(19) United States
(12) Patent Application Publication
(10) Pub. No.: US 2003/0164006 A1
(43) Pub. Date: Sep. 4, 2003

(54) Direct bonding of glass articles for drawing

(76) Inventors: Karl H. Buchanan, Kure Beach, NC (US); Glen B. Cook, Corning, NY (US); Charles M. Darcangelo, Corning, NY (US); Ronald W. Davis JR., Horseheads, NY (US); Patrick Gedeon, Painted Post, NY (US); Suresh T. Gulati, Elmira Heights, NY (US); Michael D. Harris, Horseheads, NY (US); Michael P Hobczuk, Elmira, NY (US); Jeffrey M. King, Corning, NY (US); Robert Sabia, Corning, NY (US); Gary G Squier, Beaver Dams, NY (US); Betty J. Sterlace, Painted Post, NY (US); Elizabeth M. Vileno, Corning, NY (US)

Correspondence Address: CORNING INCORPORATED, SP-TI-3-1, CORNING, NY, 14831

(21) Appl. No.: 10/232,193

(22) Filed: Aug. 28, 2002

Related U.S. Application Data
(63) Continuation-in-part of application No. 10/035,659, filed on Oct. 26, 2001.

(51) Int. Cl. C03B 37/027

(52) U.S. Cl. 65/407; 65/411; 65/412

(57) ABSTRACT

Methods of bonding glass articles that are subsequently drawn into sheets, rods, fibers, etc. are disclosed. Bonding is achieved without use of adhesives or high temperature fusion. The invention is particularly useful for bonding optical fiber preforms prior to drawing of the optical fiber.

### CROSS-REFERENCE TO RELATED APPLICATIONS

This is a continuation-in-part of U.S. patent application Ser. No. 10/035,659, filed Oct. 26, 2001, the content of which is relied upon and incorporated herein by reference in its entirety, and the benefit of priority under 35 U.S.C. §120 is hereby claimed.

### FIELD OF THE INVENTION

This invention relates to direct bonding of glass. More particularly, the invention relates to methods for direct bonding of a wide variety of glass articles that are subsequently drawn into sheets, bars tubes, fibers, or rods such as optical fiber preforms.

### BACKGROUND OF THE INVENTION

A wide variety of glass articles, such as fibers, sheets, rods, tubes and bars are formed by a glass drawing process in which a glass preform is heated to the softening point of the glass. Tension on a portion of the glass downstream from the heated portion of the glass draws the glass into its final form.

For example, in the manufacture of optical fiber, as shown in FIG. 1, a preform 10, consisting of core surrounded by a cladding is generally arranged vertically in a draw tower 12 so that a portion of the preform 10 is lowered into a furnace 14 that typically heats the preform to temperatures exceeding 2000° C. As the lower end of the preform melts in the furnace, the preform necks down from the original cross-sectional area of the preform to the desired cross-sectional area of a fiber 16. The fiber 16, which is coated in coating apparatus 18, 20 with a polymeric coating, is collected on a spool 22 until the preform 10 is exhausted. After the preform 10 has been exhausted, the draw tower is shut down until a new preform is loaded into the draw tower.

This process is inefficient in that shut down of the fiber draw tower results in equipment downtime. One way of improving this inefficiency is by increasing the size of the preform, particularly the diameter. However, a limitation of increasing the size of the preform is the size of the equipment utilized to manufacture and consolidate such preforms. In addition, it is difficult to control the optical properties of fibers produced from larger diameter preforms.

European patent application no. EP 1057793, and U.S. Pat. Nos. 4,407,667, 6,098,429 and 6,178,779 each disclose methods of joining the ends of optical fiber preforms by heating the preforms to their softening point and fusion bonding the preforms together. EP 1057793 and U.S. Pat. No. 6,178,779 disclose using a plasma torch to heat the ends of the preforms together. U.S. Pat. No. 6,098,429 states that heating the ends of the preform with a torch may degrade the optical attenuation parameters of optical fiber drawn from such fused preforms. U.S. Pat. No. 6,098,429 discloses a method of welding or fusing optical fiber preforms together by using a high power laser. Even though the method disclosed in U.S. Pat. No. 6,098,429 purportedly represents an improvement, lasers are expensive to implement and pose safety concerns in a manufacturing environment. Of even greater importance is the relative inability to create a smooth transition between the joined preform which minimizes the amount of unusable fiber from the subsequently drawn preform.

Fusion bonding relates to the process of cleaning two surfaces (glass or metal), bringing the surfaces into contact, and heating close to the softening point of the materials being bonded (to the lower softening temperature for two dissimilar materials), thus forming a welded interface. As noted above, a disadvantage of fusion bonding is that this process typically results in deformation of the two surfaces being bonded due to the flow of softened material. Fusion bonding also tends to result in an interface between the bonded surface that may include bubbles of gas. For these and other reasons fusion bonding typically results in a loss of signal transmitted through the interface for signal transmitting objects such as optical fibers, making such fiber unusable.

It would be desirable to provide a bonding process for articles that are drawn into fiber, sheets, tubes, rods and bars that does not exhibit the disadvantages of fusion bonding. In particular, in the area of drawing optical fibers, eliminating the problem of softening the ends of the preforms and causing potential attenuation problems in the optical fiber made from the preform would be advantageous. In addition, it would be useful to provide a bonding process that minimized the amount of unusable fiber and that provided high bond strength capable of holding the preforms together during the drawing process, which involves placing the glass preform under tension at high temperatures.

### SUMMARY OF INVENTION

The invention relates to methods of bonding opposing surfaces of glass articles, at temperatures below the softening point of the articles, and without adhesives, that are subsequently drawn into sheets, tubes, rods, fibers, bars and ferrules. According to one embodiment, optical fiber preforms are joined at the preform ends, and the composite preform is drawn into an optical fiber waveguide.

According to another embodiment of the invention, a method of manufacturing a glass article includes providing bonding surfaces on first and second articles by, for example, magnetorheological finishing of the bonding surfaces of the first and second articles, and attaching the bonding surfaces of the first and second articles without an adhesive and at a temperature lower than 1000° C. to provide a preform. After the articles are joined to provide a preform, the preform can be drawn to provide a fiber, a rod, a sheet, a bar or a tube. In one such embodiment, the first and second articles are optical fiber preforms and the bonding surfaces are disposed on the ends of the preforms.

The method may further involve providing a hydrophilic surface on the bonding surface of the first and the second ends of the articles. In another embodiment of the invention, the method may include forming hydrogen bonds between the bonding surfaces of the first and the second articles. Forming hydrogen bonds may include contacting the bonding surfaces of the first and second articles with an acid. In another embodiment, the method may further include providing termination groups on the bonding surfaces of the first and second articles such as —OH, ≡SiOH, ═Si(OH)₂, —Si(OH)₃, —OSi(OH)₃, and combinations thereof. Providing these functional groups may further involve contacting the ends of the first and second articles with a solution having a pH greater than 8. The solution includes a hydroxide such as ammonium hydroxide. According to this embodiment, it is preferred that adsorbed hydroxyl groups are substantially eliminated at the interface between the first and second surfaces by heating the bonding surfaces to a temperature less than the softening or deformation point of the articles. As hydrated surface groups condense under these conditions, water is formed as a byproduct.

According to another embodiment of the invention, the first and second articles are tubes and the bonding surfaces include sidewalls of the tubes. According to this embodiment, the method is useful for producing fiber ferrules. According to another embodiment, the first and second articles include a polarizing glass containing elongated crystals.

Another embodiment of the invention relates to a method of forming an optical fiber comprising the steps of bonding the end surfaces of at least two optical fiber preforms without an adhesive and at a temperature less than the softening or deformation temperature of the preforms to provide a blank and drawing optical fiber from the blank. Preferably the bonding surfaces are formed by magnetorheological finishing of the end surfaces of the two optical fiber preforms. According to this embodiment, the method involves providing termination groups, preferably, hydroxyl termination groups, on the end surfaces of the preforms. According to another embodiment, the invention may further include heating the end surfaces of the preforms such that absorbed water molecules are driven from the surface and the adsorbed hydroxyl groups remain on the end surfaces of the preforms. The method may also include forming a covalent bond between the preforms.

The invention provides a simple, low temperature, and reliable bonding method that provides bond strength capable of surviving high drawing temperatures. Bonding can occur at temperatures lower than the softening or deformation temperature of the glass, and in some cases lower than 100° C. Additional advantages of the invention will be set forth in the following detailed description. It is to be understood that both the foregoing general description and the following detailed description are exemplary and are intended to provide further explanation of the invention as claimed.

### BRIEF DESCRIPTION OF THE DRAWINGS

FIG. 1 is a diagram of a prior art optical fiber draw apparatus;

FIGS. 2a-2d are diagrams showing the steps of bonding two optical fiber preforms;

FIG. 3a is a diagram of a prior art method for drawing a sheet or bar of glass;

FIG. 3b is a diagram of a method of drawing a sheet or bar of glass according to the present invention;

FIGS. 4a-4d are diagrams showing a method of drawing a dual ferrule;

FIGS. 5-6 are illustrations of an embodiment of the present invention depicting optical fiber preforms having flat bonding surfaces.

FIGS. 7-9 are illustrations of an embodiment of the present invention depicting optical fiber preforms having non-flat bonding surfaces.

FIGS. 10a-10b are illustrations of an embodiment of the present invention that eliminates detrimental CTE effects from occurring at the bonding surfaces of optical fiber preforms to be bonded.

### DETAILED DESCRIPTION

According to the present invention, various methods can be utilized to directly bond opposing surfaces of at least two glass articles together prior to drawing the article into a sheet, a rod, a tube, a bar or a fiber. As used herein, the terms “direct bonding” and “direct bond” mean that bonding between two surfaces is achieved at the atomic or molecular level, no additional material exists between the bonding surfaces such as adhesives, and the surfaces are bonded without the assistance of fusion of the surfaces by heating. As used herein, the terms “fusion” or “fusion bonding” refer to processes that involve heating the bonding surfaces and/or the material adjacent the bonding surfaces to the softening or deformation temperature of the articles bonded. The methods of the present invention do not involve the use of adhesives or fusion bonding to bond the opposing surfaces together. Instead, the present invention utilizes methods that involve the formation of end surfaces suitable for direct bonding using such techniques as, for example, magnetorheological finishing, and forming a direct bond between such surfaces without high temperatures that soften the glass material to the point of deformation or the softening point, which typically results in an interface that is not optically clear. The present invention provides a bonding method that provides an impermeable, optically clear seal, meaning that there is essentially zero distortion of light passing between the interface of the bonded surfaces. Acceptable bonding methods include, but are not limited to, wringing, chemical bonding, and vacuum bonding. The formation of a direct bond between two glass or metal surfaces allows for an impermeable seal that has the same inherent physical properties as the bulk material surfaces being bonded.

Magnetically-stiffened magnetorheological fluids for abrasive finishing and polishing of substrates contain magnetically-soft, abrasive particles, e.g. particles that gain or lose their magnetic characteristics in the presence or absence of a magnetic field. These particles are dispersed in a liquid carrier, and exhibit magnetically-induced thixotropic behavior in the presence of a magnetic field. The apparent viscosity of the fluid can be magnetically increased by many orders of magnitude, such that the consistency of the fluid changes from being nearly watery to being a very stiff paste. When such a paste is directed appropriately against a substrate surface to be shaped or polished, for example, an optical fiber preform, a very high level of finishing quality, accuracy, and control can be achieved.

A typical magnetorheological finishing system may comprise an apparatus as described in U.S. Pat. No. 5,951,369, which is incorporated herein by reference. Such a system would typically include a work surface that comprises a vertically-oriented wheel having an axially-wide rim which is, undercut symmetrically about a hub. Specially shaped magnetic pole pieces, which are symmetrical about a vertical plane containing the axis of rotation of the wheel, are extended toward opposite sides of the wheel under the undercut rim to provide a magnetic work zone on the surface of the wheel, preferably at about the top-dead-center position. The surface of the wheel may be flat, i.e., a cylindrical section, or it may be convex, i.e., a spherical equatorial section, or it may be concave. The convex shape can be particularly useful as it permits finishing of concave surfaces having a radius longer than the radius of the wheel.

Wringing refers to a process of bonding glass surfaces in which adsorbed surface groups are removed from active bonds on a surface by heating the parts to temperatures typically above 600° C. but below the softening point of the glass. Absorbed water and organics will vaporize and the resulting surface sites become “active.” At such a temperature, or after cooling in a clean, low humidity environment, surfaces can be placed in contact, at which point covalent bonds spontaneously form between “active” bonds on each surface. This is similar to vacuum bonding, except the surface is activated by temperature rather than by a strong vacuum.

Vacuum bonding involves bringing two clean surfaces into contact in a high vacuum, thus forming a bond. Provided that the surfaces are flat and clean, a high vacuum removes absorbed water and hydrocarbons from the surface while preventing the adsorption of such species. Surfaces can be cleaved in the vacuum, processed and cleaned before being placed in the vacuum, or cleaned in the vacuum via ion milling or other plasma techniques.

Within the microelectronics field, vacuum bonding has been developed for sealing of such materials as single crystal silicon, thermal oxide SiO₂ grown on Si, and various metals, as described in U.S. Pat. No. 6,153,495. Coefficient of thermal expansions (CTE) mismatch between materials is not an issue because the process can be applied at room temperature. Because polished wafers are thin and typically non-flat due to the Twyman effect, special fixturing can be used to apply pressure evenly across the entire wafer surface to generate appropriate contact.

Another type of bonding process that may be utilized according to the present invention involves chemical bonding. The formation of a chemical bond between two glass or metal surfaces allows for an impermeable seal that has the same inherent physical properties as the bulk material being bonded. In literature, low-temperature bonding technology has been reported for bonding soda-lime-silicate glass and for crystalline quartz (see, e.g., A. Sayah, D. Solignac, T. Cueni, “Development of novel low temperature bonding technologies for microchip chemical analysis applications,” Sensors and Actuators, 84 (2000) pp. 103-108 and P. Rangsten, O. Vallin, K. Hermansson, Y. Backlund, “Quartz-to-Quartz Direct bonding,” J. Electrochemical Society, V. 146, N. 3, pp. 1104-1105, 1999). Both the Sayah and Rangsten references, disclose using acid cleaning techniques. Another article, H. Nakanishi, T. Nishimoto, M. Kani, T. Saitoh, R. Nakamura, T. Yoshida, S. Shoji, “Condition Optimization, Reliability Evaluation of SiO2—SiO2 HF Bonding and Its Application for UV Detection Micro Flow Cell,” Sensors and Actuators, V. 83, pp. 136-141, 2000, discloses low-temperature bonding of fused SiO₂ by first contacting the bonding surfaces with hydrofluoric acid.

According to one embodiment of the invention, functional groups are provided on opposing surfaces of the articles to be bonded. No adhesives, high temperature pre-treatment or caustic hydrofluoric acid treatments are required prior to bonding the opposing surfaces. In one such embodiment of the invention, a surface treatment of a high pH base solution such as sodium hydroxide, potassium hydroxide or ammonium hydroxide is utilized to provide functional groups on the bonding surfaces of the articles. In a preferred embodiment, the surfaces are first cleaned using a detergent followed by rinsing with an acid solution such as a nitric acid solution to remove particulate contamination and soluble heavy metals respectively.

According to another embodiment of the invention, the surfaces are contacted with a high pH solution, rinsed, pressed into contact and gradually heated to the desired temperature, preferably to a temperature less than 300° C. It is preferable to use a “clean” heat source that does not introduce contaminants or byproducts to interfere with bonding. Such heat sources include, but are not limited to, induction heating, microwave heating, radio frequency (RF) heating and electric resistance heating. To enhance bonding, it is preferred that the surfaces are flat, as determined by performing a preliminary cleaning and pressing the dried samples into contact. Resulting interference fringes can be acquired according to techniques known in the art and interpreted to determine matching flatness. Also, an optical flat or interferometer can be used to evaluate individual surface flatness.

Preferably, the bonding process of the present invention consists of machining each surface to be sealed to an appropriate flatness. Particularly, preferred flatness levels are less than about 5 microns, more preferably less than about 1 micron, and most preferably less than about 0.25 micron. Preferably, surface roughness levels are less than about 2.0 nm RMS. After polishing, each surface is preferably cleaned with an appropriate cleaning solution such as a detergent, soaked in a low pH acidic solution, and soaked in a high pH basic solution to generate a clean surface with silicic acid-like (i.e., ≡Si—OH, ═Si—(OH)₂, —Si—(OH)₃ and —O—Si—(OH)₃) terminated surface groups. In a preferred embodiment, the surfaces are assembled without drying. A low to moderate load (as low as 1 PSI) is then applied as the surfaces are heated to less than 300° C., for example, between 100-200° C., so that absorbed water evaporates and silicic acid-like surface groups condense to form a covalently-bonded interface.

According to an embodiment of the invention, as noted above, it is desirable to provide bonding surfaces that are flat. It is preferred to have surfaces finished to 5 micron flatness or better, preferably 1 micron flatness or better, and more preferably 0.25 flatness or better on the surfaces to be bonded.

For glass surfaces having a high percentage of silica, higher temperature heating is not necessarily required to form high strength bonds. For higher silica systems, heating below 300° C. is usually sufficient to form a high strength bond. On the other hand, samples that have a lower amount of silica in the glass composition may require heating to higher temperatures to form a satisfactory bond. For example, Pyrex® glass (containing approximately 81% silica) and Polarcor™ (containing approximately 56% silica), which are borosilicate glasses may require additional heating to provide sufficient bond strength for applications requiring high bond strength. The degree of heating for different bonding surfaces and glass surfaces will depend in part on the type of surface to be bonded (e.g., a fiber or a flat surface) and the desired bond strength for a particular application.

We have found that high silica surfaces with low water content need not be heated prior to bonding. Satisfactory bonding can be achieved at temperatures preferably less than about 300° C., more preferably less than about 200° C., and most preferably less than about 100° C. In addition, it was discovered that cleaning the surfaces with acid and base solutions is also not necessary to form a complete bond. For high-silica surfaces it is sufficient to clean the bonding surfaces with detergent, allow the surfaces to dry, and bring the surfaces into contact at a temperature less than about 300° C., more preferably less than about 200° C., and most preferably less than about 100° C.; and at a pressure of less than about 50 psi, preferably less than about 25 psi, more preferably less than about 10 psi and most preferably less than about 1 psi.

It is expected that the methods of the present invention will provide bonding strength sufficient to withstand high temperature drawing and the tension applied to preforms during drawing. Preliminary results indicate that the bonding strength of high purity fused silica exceeded 150 psi. Details on the bond strength and additional information on a preferred embodiment of chemically bonding glass surfaces may be found in copending United States patent application entitled, “Direct Bonding of Articles Containing Silicon,” commonly assigned to the assignee of the present patent application and naming Robert Sabia as inventor. However, the present invention is not limited to the chemical bonding methods disclosed in the copending patent application, and it is believed that other chemical bonding techniques, such as wringing and vacuum bonding, can be utilized in accordance with the present invention.

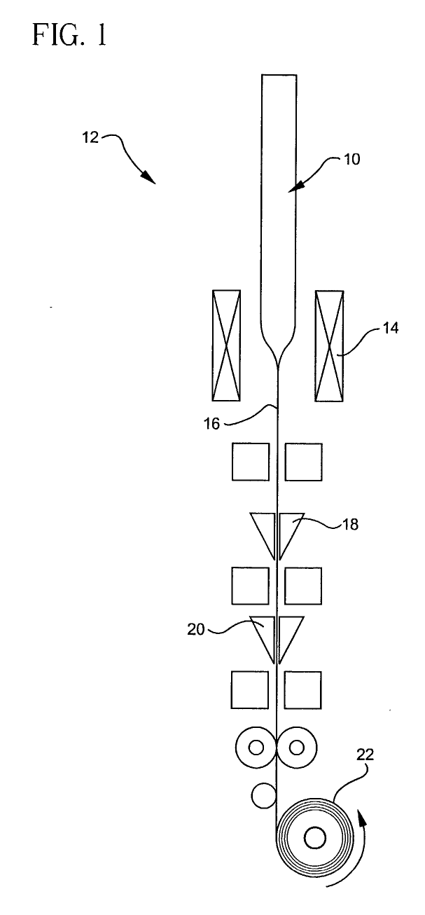

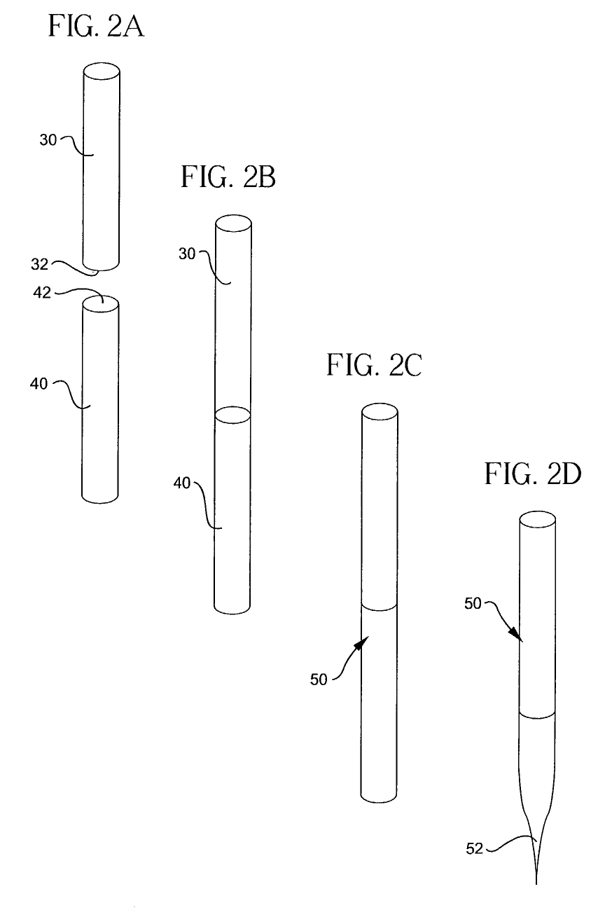

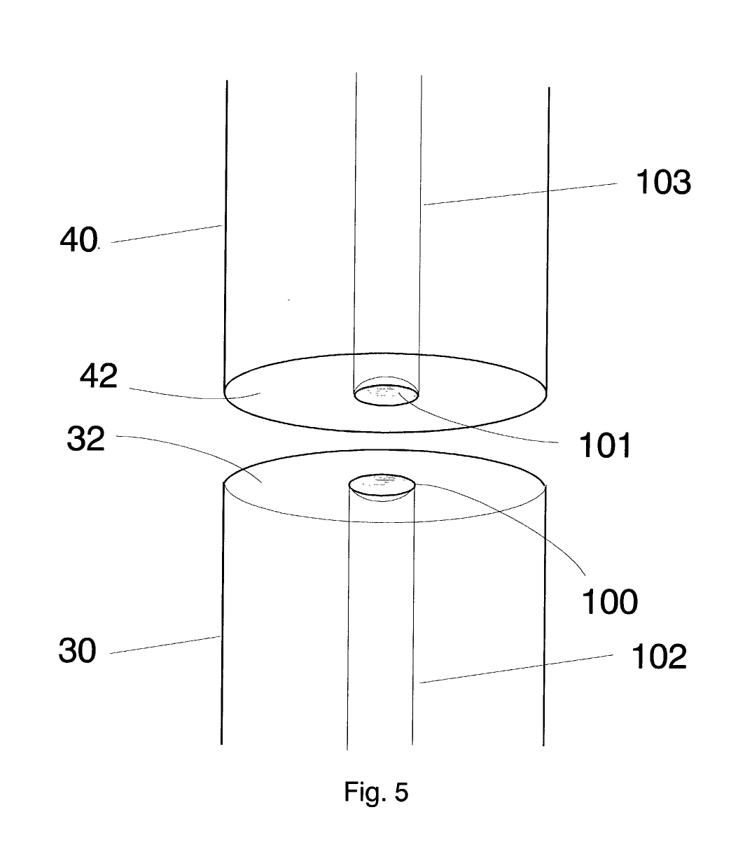

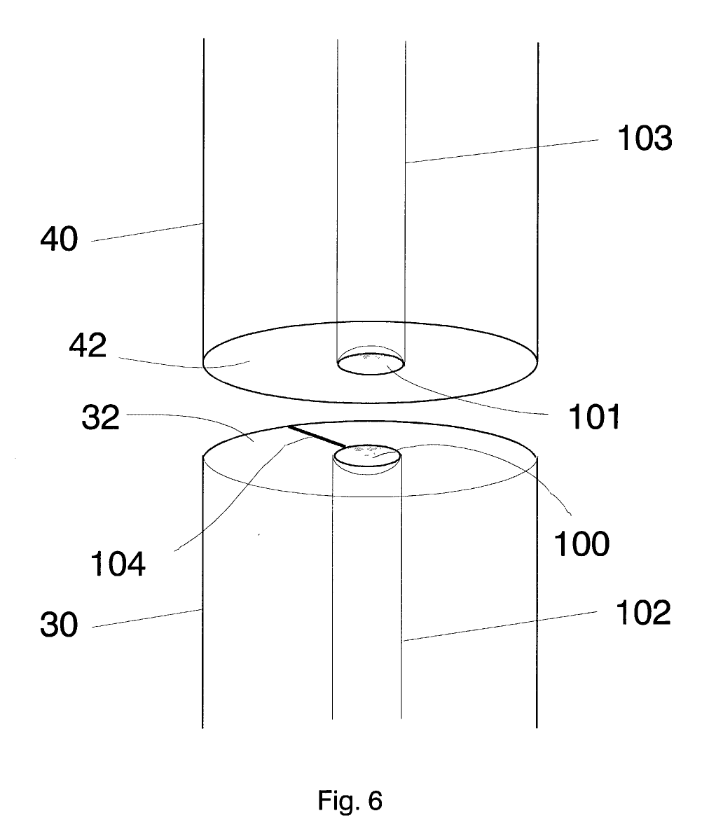

In one particular embodiment of the invention, optical fiber preforms can be bonded together prior to drawing into an optical fiber. Referring to FIGS. 2a-2d, at least two optical fiber preforms 30, 40 are provided, and opposing endfaces 32, 42 of the preforms are ground and polished using, for example, magnetorheological finishing so that the endfaces 32 and 42 have a flatness of at least 1 micron and a surface roughness less than about 2 nm RMS. Preferably, endfaces 32 and 42 have a flatness less than about 0.25 micron. In a preferred embodiment, and as shown in FIG. 5, because the core glass and the cladding glass of an optical fiber preform typically have differing coefficients of thermal expansion (CTE) resulting from the composition of each glass, that is each glass will change volume a different amount for a given temperature change, a recess 100 may be further machined into endface 32 within the circumference of the core region 102. Preferably, a recess is machined into both endfaces 32 and 42. Since the doped core region of an optical fiber preform has a higher CTE than the typically pure silica cladding region of the preform, such recessing of the core region provides room for expansion of the core that may occur during draw process heating. Without such recessing, expansion of the cores of bonded preforms during heating may be sufficient to cause contact between the core regions and result in separation of the preforms. Referring to FIG. 6, to further provide a channel for the release, during the fiber draw process, of any air or moisture that may be trapped between the opposing recessed core regions once the performs are bonded, channel 104 is preferably machined into at least one bonding surface prior to bonding, said channel extending from the recessed core region to the outer circumference of the cladding region. After forming, the bonding surfaces are then joined together by wringing, vacuum bonding, or chemical bonding, without using an adhesive or raising the temperature of the endfaces of the optical fiber preforms to the deformation temperature of the preform material. According to one embodiment, the endfaces are contacted with a solution that provides termination groups on the endfaces 32 and 42. The endfaces may be contacted with an acid solution and/or a high pH solution. Treatment with an acid will provide hydroxyl termination groups on the endfaces of the preforms. Subsequent treatment with a solution having a pH greater than 8 will provide silicic acid-like termination groups on the surface of the endfaces. After treatment of the endfaces with a solution, the endfaces 32 and 42 are joined together as shown in FIG. 2b. Thereafter, it may be desirable to heat the joined preforms together to a temperature below the softening point or deformation temperature of the preforms, e.g., below 1000° C. to provide a unitary optical fiber blank 50, as shown in FIG. 2c. Preferably, the optical fiber blank 50 should not have a gap at any location at the bonded interface between the preforms making up the composite preform, or blank, in excess of 1 micron. In combination with the bonding techniques of the present invention, this helps ensure that the bonding strength between the constituent preforms of the composite optical fiber preform exceeds at least about 150 kpsi. The composite preform can then be inserted in a drawing apparatus shown in FIG. 1 to produce an optical fiber 52 as shown in FIG. 2d. Alternatively, the preform 50, can be drawn to produce a rod 54, as shown in FIG. 2e; e.g. a core-cane rod utilized as a precursor article for use in the manufacture of optical fiber preforms. In a preferred embodiment, the bonding surfaces are washed with a detergent after finishing and dried. The bonding surfaces are brought together at room temperature and a pressure of greater than 1 psi to provide a unitary blank 50 as shown in FIG. 2c.

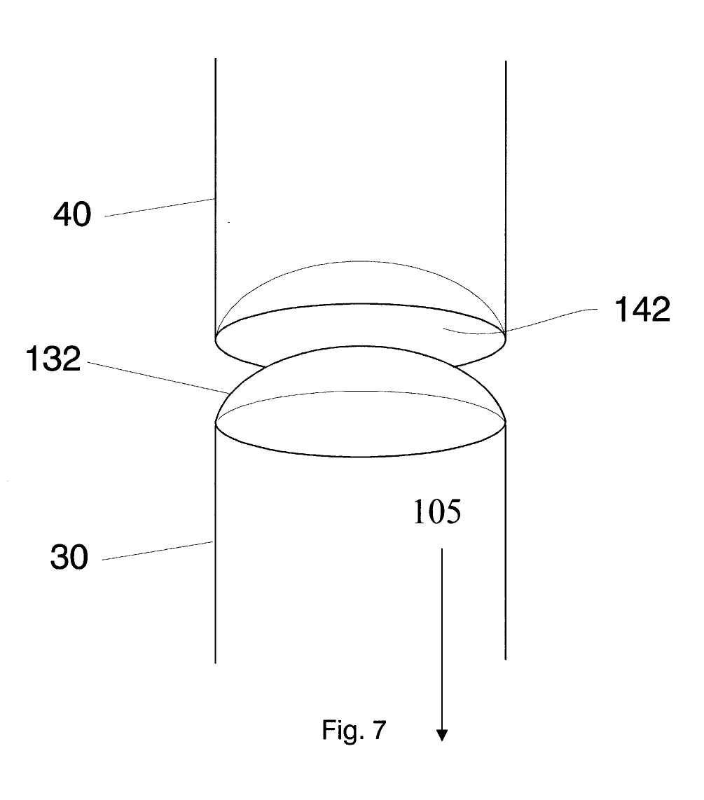

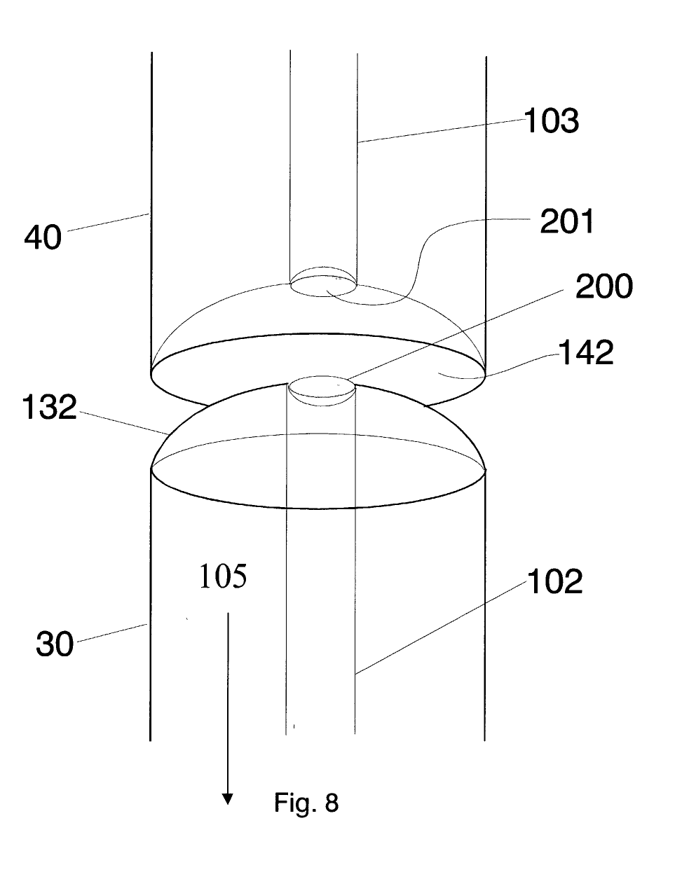

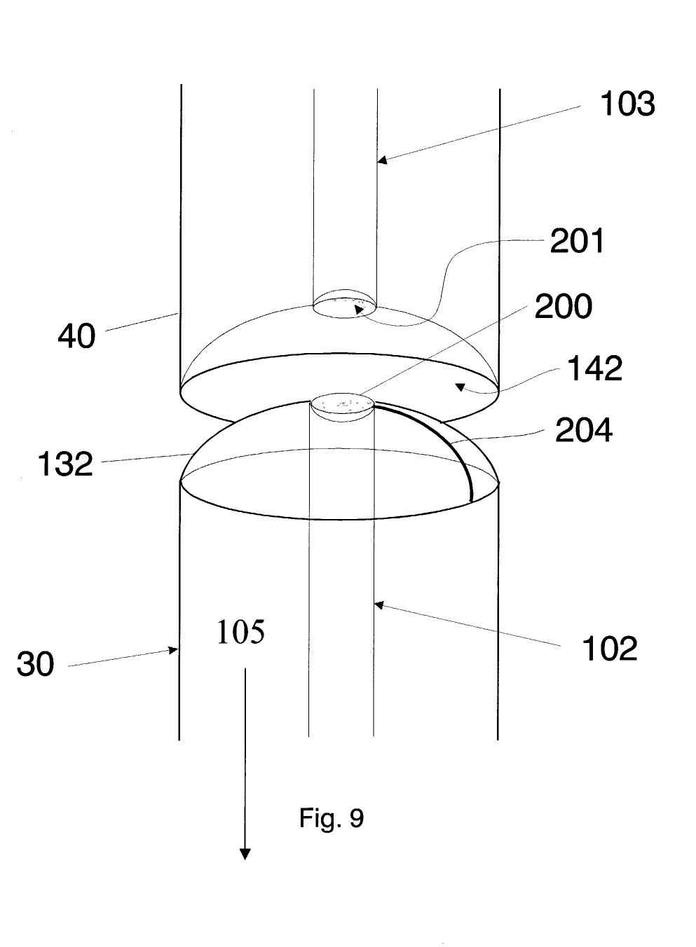

In another embodiment of the invention, optical fiber preforms having shaped, non-flat bonding surfaces can be bonded together prior to drawing into an optical fiber. Referring to FIG. 7, at least two optical fiber preforms 30, 40 are provided as before, and opposing endfaces 132 and 142 of the preforms are ground and polished using, for example, magnetorheological finishing such that one endface is concave and the other endface is convex. The endfaces are finished such that endfaces 132 and 142 fit one within the other. The matching concave-convex nature of the opposing bonding surfaces provides an aid to alignment of the preforms. The endfaces 132 and 142 have a surface roughness less than about 2 nm RMS. Preferably, fiber preforms 30 and 40 are bonded such that the preform having the convex bonding surface will be the first portion of the composite preform entering the draw furnace, and therefore the preform end from which fiber is drawn. Assembly and drawing of the composite preform in this manner minimizes perturbations in the optical properties of optical fiber drawn from the composite preform. Preferably the composite optical fiber preform should not have a gap at any location at the bonded interface between the preforms making up the composite preform in excess of 1 micron. In combination with the bonding techniques of the present invention, this helps ensure that the bonding strength between the constituent preforms of the composite optical fiber preform exceeds at least about 150 kpsi. In a preferred embodiment, and as shown in FIG. 8, a recesses 200 is further machined into the bonding surface within the circumference of core regions 102 of perform 30 to provide room for thermal expansion. Preferably, a recess is machined into the bonding surface of both preforms 30 and 40. Referring to FIG. 9, to further provide a channel for the release, during the fiber draw process, of any air or moisture that may be trapped between the opposing core regions once the performs are bonded, channel 200 is preferably machined into at least one bonding surface 232 or 242 prior to bonding, said channel extending from the recessed core region to the outer circumference of the cladding region. Channel 200 may be formed in either or both preform bonding surfaces. Preferably, fiber preforms 30 and 40 are bonded such that the preform having the convex bonding surface will be the first portion of the composite preform entering the draw furnace, and therefore the end from which fiber is drawn. Assembly and drawing of the composite preform in this manner minimizes perturbations in the optical properties of optical fiber drawn from the composite preform. Although concave-convex bonding surfaces have been discussed, those skilled in the art will appreciate that other matching shapes are also possible.

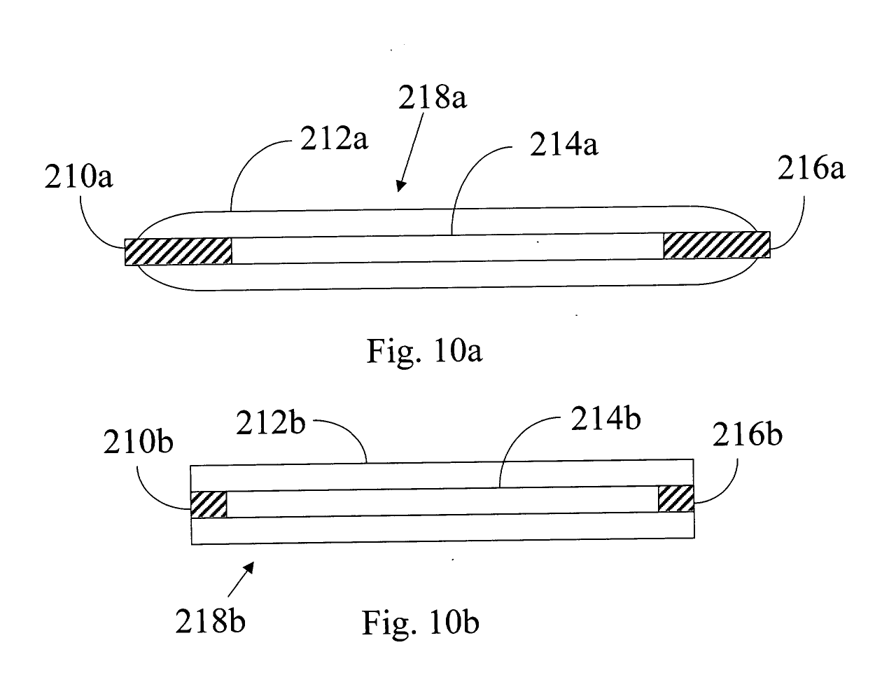

In another embodiment of the invention, an optical fiber preform 218a, as shown in FIG. 10a, is manufactured such that glass rod 210a and glass rod 216a, each having a CTE matched to a glass core rod 214a are welded to each end of glass core rod 214a prior to the addition of cladding glass 212a. For example, glass rods 210a and 216a may be pure fused silica. Glass core rod 214a serves as the starting member for the manufacture of a optical fiber preform, and glass rods 210a and 216a form a handle at each end of glass core rod 214a. Glass core rod 214a contains at least a portion of the core region of the complete optical fiber preform. Glass core rod 214a may also contain at least a portion of the cladding. Cladding glass 212a may be added by chemical vapor deposition means, by sleeving with a suitable glass tube, or by other means known to those skilled in the art. The cladding material 212a overlaps glass rod handles 210a and 216a at each end of preform 218a. As shown in FIG. 10b, once the complete optical fiber preform 218b has been formed, each end of the completed preform 218b is cut in such a manner that preferably between ½ to 1 inch of the glass rod handles 210b and 216b remains at each end of preform 218b. The bonding surfaces at the ends of preform 218b may then be formed by magnetorheological finishing and bonded in accordance with the present invention to a similar preform prepared in a like manner to form a composite optical fiber without incurring detrimental CTE mismatch effects such as separation of the preform during subsequent drawing of the composite optical fiber preform. The bonding surfaces of the individual preforms may be formed flat or they may be formed non-flat, such as, for example, in a concave-convex relationship described previously. The composite optical fiber preform should not have a gap at any location at the bonded interface between the preforms making up the composite preform in excess of 1 micron. In combination with the bonding techniques of the present invention, this helps ensure that the bonding strength between the constituent preforms of the composite optical fiber preform exceeds at least about 150 kpsi. This further ensures that the bonded preforms do not separate during the fiber drawing process. Although optical fiber drawn from the composite preform of this embodiment and which corresponds to glass rod handle remnants 210b and 216b must be discarded, this embodiment advantageously eliminates the need to form recesses, such as those depicted in FIGS. 5, 6, 8 or 9, at the core region of the bonding surfaces to avoid CTE mismatch effects.

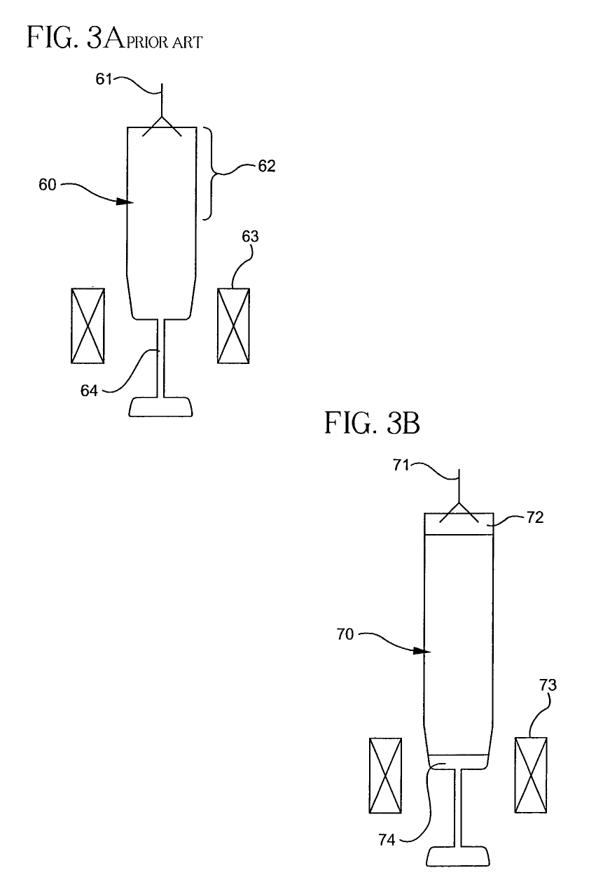

In another embodiment of the invention, direct bonding can be utilized to bond other glass articles such as, bar and/or sheets and the like. Such direct bonding that does not involve heating the glass articles to the softening point of the articles to be bonded is advantageous to prevent deterioration of the optical properties by heating to the softening point. For example, as shown in FIG. 3a, according to a prior art process for drawing bars from a preform 60, a first section 62 of the preform 60 is sacrificed because a clamping or holding mechanism 61 must be attached to the first section 62 to hold the preform 60 during drawing. Similarly, a lower section 64 of the preform 60 is also sacrificed during the drawing process when the preform 60 is lowered into the heating element 63 for heating the preform for drawing. According to the present invention, and as shown in FIG. 3b, sacrificial preform sections 72 and 74 may be directly attached to the preform 70 prior to drawing. The sacrificial preform sections 72 and 74 and the preform 70 are provided with flat opposing surfaces. The opposing surfaces of sacrificial section 72 and preform 70 are brought into contact, and the holding or clamping mechanism 73 can be attached to sacrificial section 72. Opposing sections of sacrificial section 74 and the preform 70 are also brought into contact. Sacrificial section 74 is then lowered into heating element 73, preventing the loss of material from the preform 70. In one preferred embodiment, termination groups such as hydroxyl groups or silicic acid-like groups are provided on the opposing surfaces prior to contacting the surfaces.

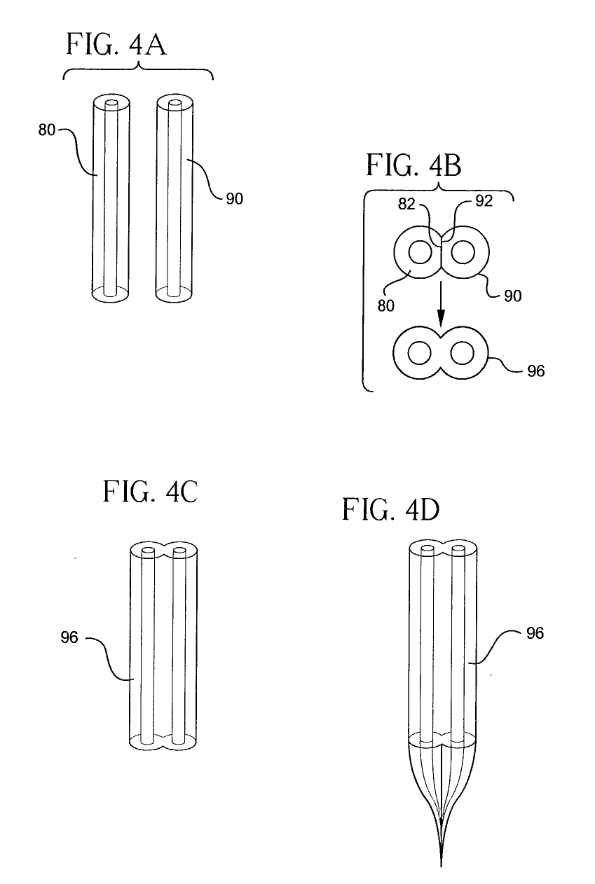

In another embodiment, the direct bonding techniques of the present invention can be utilized to bond opposing lateral surfaces of tubes that are subsequently drawn into a dual ferrule, which are used in connecting optical fibers. According to this embodiment, as shown in FIGS. 4a-4d, pair of glass tubes 80 and 90, such as Pyrex® glass tubes are provided. Lateral surfaces 82 and 92 of the tubes 80 and 90 are ground, polished and cleaned according to the present invention. The lateral surfaces 82 and 92 are then held together and directly bonded by vacuum bonding, wringing or chemical bonding. According to a preferred embodiment, the lateral surfaces 82 and 92 are contacted with an acid such as nitric acid, and then the lateral surfaces are contacted with a high pH solution such as a solution of ammonium hydroxide. Preferably, the surfaces are held together under moderate pressure of greater than one pound per square inch and heated to form a covalent bond between the tubes 80 and 90. For Pyrex® tubes, preferably the tubes are heated to a temperature exceeding 400° C., but lower than the softening point of Pyrex®, which is approximately 675° C. The resulting product is a dual tube 96 that can be drawn into a dual ferrule structure.

It will be apparent to those skilled in the art that various modifications and variations can be made to the present invention without departing from the spirit or scope of the invention. Thus, it is intended that the present invention cover modifications and variations of this invention provided they come within the scope of the appended claims and their equivalents.

What is claimed is:

1. A method of manufacturing a glass article comprising:
providing bonding surfaces on first and second glass articles;
attaching the bonding surfaces of the first and second glass articles without an adhesive and at a temperature lower than softening temperature of the glass articles to provide a preform; and
drawing the preform to provide a fiber, a rod, a sheet, a bar or a tube.

2. The method of claim 1, wherein the first and second glass articles are optical fiber preforms and the bonding surfaces are disposed on the ends of optical fiberpreforms.

3. The method of claim 1, further including the step of providing a hydrophilic surface on the bonding surfaces of the first and the second glass articles.

4. The method of claim 3, further including forming hydrogen bonds between the bonding surfaces of the first and the second glass articles.

5. The method of claim 4, further including a step of contacting the bonding surfaces of the first and second glass articles with an acid.

6. The method of claim 4, further including a step of providing termination groups on the bonding surfaces of the first and second glass articles selected from the group consisting of —OH, ≡Si—OH, ═Si—(OH)₂, —Si—(OH)₃ and —O—Si—(OH)₃, and combinations thereof.

7. The method of claim 6, further including a step of contacting the ends of the first and second glass articles with a solution having a pH greater than 8.

8. The method of claim 7, wherein the solution includes a hydroxide.

9. The method of claim 8, wherein the solution includes ammonium hydroxide.

10. The method of claim 6, further including a step of eliminating adsorbed hydroxyl groups at an interface between the first and second surfaces.

11. The method of claim 10, wherein the step of eliminating involves heating the bonding surfaces to a temperature less than 500° C.

12. The method of claim 1, wherein the first and second glass articles are tubes and the bonding surfaces include sidewalls of the tubes.

13. The method of claim 1, wherein the first and second glass articles include a polarizing glass.

14. A method of manufacturing an optical fiber preform assembly comprising a step of:
attaching ends of a first and second optical fiber preforms without an adhesive and at a temperature less than the softening temperature of the preform.

15. The method of claim 14, further including a step of providing adsorbed hydroxyl groups on the ends of the first and second optical fiber preforms.

16. The method of claim 15, further including the step of contacting the ends of the preforms with an acid.

17. The method of claim 16, further including a step of contacting the ends of the preforms with a solution having a pH greater than 8.

18. The method of claim 17, wherein the solution includes ammonium hydroxide.

19. The method of 17, further including a step of providing a moist surface on the ends of the preforms.

20. The method of claim 19, further including a step of heating the preforms such that adsorbed hydroxyl groups remain on the ends of the preforms.

21. The method of claim 20, further including a step of forming a covalent bond between the ends of the preforms.

22. A method of forming an optical fiber comprising the steps of:
bonding end surfaces of at least two optical fiber preforms without an adhesive and at a temperature less than the softening temperature of the preforms to provide a blank; and
drawing optical fiber from the blank.

23. The method of claim 22, further comprising a step of providing termination groups on the end surfaces of the preforms.

24. The method of claim 23, further comprising the step of providing hydroxyl termination groups on the end surfaces of the preforms.

25. The method of claim 24, further comprising the step of contacting the end surfaces of the preforms with an acid.

26. The method of claim 25, further comprising the step of providing termination groups on the end surfaces of the preforms selected from the group consisting of —OH, ≡Si—OH, ═Si—(OH)₂, —Si—(OH)₃ and —O—Si—(OH)₃, and combinations thereof.

27. The method of claim 26, further including the step of contacting the end surfaces of the preforms with a solution having a pH greater than 8.

28. The method of claim 27, wherein the solution includes ammonium hydroxide.

29. The method of claim 26, further comprising the step of providing absorbed water molecules and adsorbed hydroxyl groups on the end surfaces of the preform.

30. The method of claim 29, further comprising the step of heating the end surfaces such that the adsorbed hydroxyl groups remain on the end surfaces of the preforms.

31. The method of claim 29, further comprising the step of forming a covalent bond between the preforms.

32. An optical fiber waveguide made by the method of claim 22.

33. A method of forming an optical fiber comprising;
forming bonding surfaces on first and second optical fiber preforms using an abrasive, magnetically-stiffened fluid;
attaching the bonding surfaces of said first and second optical fiber preforms without an adhesive and at a temperature lower than the softening temperature of said first and second optical fiber preforms to provide a blank; and
drawing said blank to provide an optical fiber.

34. The method of claim 33 wherein said attaching step is performed at a temperature of less than about 300° C.

35. The method of claim 33 wherein said attaching step is performed at a temperature of less than about 200° C.

36. The method of claim 33 wherein said attaching step is performed at a temperature of less than about 100° C.

37. The method of claim 33 wherein said attaching step is performed at a pressure of less than about 50 psi.

38. The method of claim 33 wherein said attaching step is performed at a pressure of less than about 25 psi.

39. The method of claim 33 wherein said attaching step is performed at a pressure of less than about 10 psi.

40. The method of claim 33, wherein said forming step comprises shaping the bonding surfaces on said first and second optical fiber preforms such that they are substantially flat.

41. The method of claim 40 wherein the bonding surfaces on said first and second optical fiber preforms are shaped to a flatness of less than about 1 micron and a roughness of less than about 2.0 nm RMS.

42. The method of claim 40 wherein the bonding surfaces on said first and second optical fiber preforms are shaped to a flatness of less than about 0.25 micron and a surface roughness of less than about 2.0 nm RMS.

43. The method of claim 33, wherein said forming step further comprises shaping the bonding surfaces on said first and second optical fiber preforms such that substantially the entire bonding surface of said first optical fiber preform is concave and substantially the entire bonding surface of said second optical fiber preform is convex.

44. The method of claim 43, wherein the bonding surfaces on said first and second optical fiber preforms are shaped to a roughness of less than about 2.0 nm RMS.

45. The method of claim 40, wherein a recess is shaped within the circumference of the core region of at least one of said first and second optical fiber preforms.

46. The method of claim 43, wherein a recess is shaped within the circumference of the core region of at least one of said first and second optical fiber preforms.

47. The method of claim 45 or claim 46, wherein a channel is formed in said first and second optical fiber bonding surfaces, wherein said channel extends from said recess to the outer circumference of said first and second optical fiber preforms.

48. The method of claim 33 further comprising;
a) Prior to said forming bonding surfaces step, providing at least a first and second glass core rod,
b) welding a glass rod handle to each end of said at least first and second glass core rods,
c) overcladding said at least first and second glass core rods to form at least first and second optical fiber preforms, wherein said overcladding overlaps said glass rod handles, and
d) cutting said first and second optical fiber preforms such that between ½ and 1 inch of said glass rod handles remain attached to said at least first and second glass core rods and wherein said remaining glass rod handles are exposed at the endfaces of said at least first and second optical fiber preforms.
